(19) United States
(12) Patent Application Publication
(10) Pub. No.: US 2024/0341359 A1
(43) Pub. Date: Oct. 17, 2024

(54) HEAT EXCHANGER, SECTIONAL HEATING DEVICE, AND AEROSOL GENERATING DEVICE

(71) Applicant: SHENZHEN INNOKIN TECHNOLOGY CO., LTD., Shenzhen (CN)

(72) Inventors: Zhengzhan PENG, Shenzhen (CN); Jianwei LI, Shenzhen (CN); Tao CUI, Shenzhen (CN); Fang LEI, Shenzhen (CN)

(73) Assignee: SHENZHEN INNOKIN TECHNOLOGY CO., LTD., Shenzhen (CN)

(21) Appl. No.: 18/751,338

(22) Filed: Jun. 23, 2024

Related U.S. Application Data
(63) Continuation of application No. PCT/CN2022/141005, filed on Dec. 22, 2022.

(30) Foreign Application Priority Data
Dec. 24, 2021 (CN) 202123300320.3
Jul. 12, 2022 (CN) 202221792502.9

(51) Int. Cl. A24F 40/46; A24D 1/20; A24F 40/20; A24F 40/485; H05B 3/26

(52) U.S. Cl. CPC A24F 40/46; A24D 1/20; A24F 40/20; A24F 40/485; H05B 3/265

(57) ABSTRACT

A heat exchanger, a sectional heating device, and an aerosol generating device are disclosed herein. The aerosol generating device includes: a housing, which is provided with a first air intake hole and is internally provided with an airflow channel and an accommodating cavity for accommodating an herbal product, with external air entering the airflow channel through the first air intake hole; and a porous conductive ceramic body, which is located in the housing and at least partially located between the accommodating cavity and the airflow channel, and is configured to heat the air that flows through the porous conductive ceramic body and enters the accommodating cavity, so that the herbal product is heated by the heated air.

### CROSS-REFERENCE TO RELATED APPLICATION

The present application is a continuation of International Application No. PCT/CN2022/141005, filed on Dec. 22, 2022, which claims the benefit of priority to Chinese Patent Application No. 202123300320.3, titled “HEATING ASSEMBLY, HEAT EXCHANGER AND AEROSOL GENERATING DEVICE” and filed with the China National Intellectual Property Administration on Dec. 24, 2021, and Chinese Patent Application No. 202221792502.9, titled “SEGMENTED HEATING DEVICE, AND HEAT-NOT-BURN DEVICE” and filed with the China National Intellectual Property Administration on Jul. 12, 2022. The entire disclosures of the above applications are incorporated herein by reference.

### TECHNICAL FIELD

The present application pertains to the technical field of electronic atomization, and in particular to a heat exchanger, a segmented heating device, and an aerosol generating device.

### TECHNICAL BACKGROUND

There are mainly two types of aerosol generating devices on the market, namely, an electronic atomization device and a low-temperature non-combusted smoking set. The electronic atomization device forms smokable aerosols by evaporating e-liquids, and the low-temperature non-combusted smoking set forms smokable aerosols by heating an herbal product at a low temperature ranging from 200° C. to 400° C. Compared with conventional combusting cigarettes, both of the electronic atomization device and the low-temperature non-combusted smoking set work at a lower temperature, and produce aerosols with much less harmful compositions than the conventional combusting cigarettes from the e-liquids or the herbal product. As a result, the electronic atomization device and the low-temperature non-combusted smoking set remarkably reduce negative effects of the conventional combusting cigarettes on the human body.

The low-temperature non-combusted smoking set usually heats the herbal product at the low temperature to generate the smokable aerosols in two ways, namely peripheral heating and central heating. In the central heating, a heating sheet or a heating pin usually serves as a heater. The heating sheet or the heating pin is inserted into the herbal product, and generates heat to heat and atomize the herbal product. When the heating sheet or the heating pin is heating, it may easily generate a significant temperature gradient along a radial direction of the herbal product. Specifically, the heat spreads along a direction from a center of the heating sheet to a periphery, causing a relatively high temperature in a center heating region and a relatively low temperature in a peripheral heating region, so the herbal product is heated unevenly. More specifically, a part of the herbal product close to the center heating region is sufficiently heated, while another part of the herbal product away from the center heating region is insufficiently heated. Therefore, little smoke is formed by the aerosols, which makes the aerosols taste bad and affects the smoking experience of a user.

### SUMMARY

A primary goal of the present application is to provide a heat exchanger, a segmented heating device, and an aerosol generating device, so as to solve the technical problem that an herbal product is unevenly heated in an existing low-temperature non-combusted smoking set, which may otherwise make aerosols taste bad and affects the smoking experience of a smoker.

To achieve the above goal, an aerosol generating device configured for heating an herbal product is provided according to the present application. The aerosol generating device includes an outer housing and an air heater, where:
an air channel and an accommodation cavity for accommodating the herbal product are provided in the outer housing, the outer housing is provided with at least one first air inlet hole, and air from an exterior is enterable into the air channel through the first air inlet hole; and
the air heater includes a porous conductive ceramic being mounted in the outer housing, at least a part of the porous conductive ceramic is located between the accommodation cavity and the air channel, and multiple pores for the air to pass through are distributed throughout the porous conductive ceramic, and the porous conductive ceramic is configured for heating air that flows through the porous conductive ceramic and enters the accommodation cavity, which allows the heated air to heat the herbal product.

In some embodiments, the at least one first air inlet hole is defined at an end portion of an end of the outer housing away from the accommodation cavity.

In some embodiments, an interlayer having a cavity is provided in a side wall of the outer housing, and the at least one first air inlet hole is defined at a top end of the interlayer at an end of the outer housing close to the accommodation cavity.

In some embodiments, an interlayer having a cavity is provided in a side wall of the outer housing, and the first air inlet hole is defined on the side wall of the outer housing at an end of the outer housing close to the accommodation cavity.

In some embodiments, a porosity of the porous conductive ceramic ranges from 30% to 70%.

In some embodiments, a pore-opening degree of the porous conductive ceramic is larger than or equal to 90%.

In some embodiments, at least one layer of a thermal insulation material is provided outside an outer surface of the porous conductive ceramic, and the thermal insulation material is provided with at least one second air inlet hole in communication with the air channel and at least one air outlet hole in communication with the accommodation cavity.

In some embodiments, the thermal insulation material is a dense ceramic housing or a ceramic glaze layer.

In some embodiments, the at least one second air inlet hole is provided on the thermal insulation material on the porous conductive ceramic and is away from the accommodation cavity.

In some embodiments, the at least one air outlet hole is provided on the thermal insulation material on the porous conductive ceramic and is close to the accommodation cavity.

In some embodiments, the air heater includes a positive pin and a negative pin, and the porous conductive ceramic is electrically connected to the positive pin and the negative pin.

In some embodiments, the porous conductive ceramic includes a first end and a second end that are opposite to each other, the positive pin is electrically connected to the first end, and the negative pin is electrically connected to the second end.

In some embodiments, the porous conductive ceramic includes a first end and a second end that are opposite to each other, the positive pin is provided at an outer side face of the porous conductive ceramic and is close to the first end, and the negative pin is provided at the outer side face of the porous conductive ceramic and is close to the second end.

In some embodiments, a position on the porous conductive ceramic where the positive pin is provided and a position on the porous conductive ceramic where the negative pin is provided are spaced apart along a circumferential direction of the porous conductive ceramic.

In some embodiments, the porous conductive ceramic is of a cylindrical shape, a conical shape, a helical shape, a trapezoidal shape, a dumbbell shape, a concave shape, a spherical shape, or an irregular shape.

In some embodiments, the porous conductive ceramic is vertically and coaxially arranged in the outer housing.

In some embodiments, the porous conductive ceramic is transversely arranged in the outer housing, and a certain included angle is included between an axial direction of the porous conductive ceramic and an axial direction of the outer housing.

In some embodiments, the aerosol generating device includes a power supply assembly, and the power supply assembly is mounted in the outer housing and is electrically connected to the porous conductive ceramic.

In some embodiments, the power supply assembly includes a power supply and a control board, and the control board is electrically connected to the power supply and the porous conductive ceramic.

In some embodiments, the herbal product includes a first herb segment and a second herb segment that are connected as a whole;
the aerosol generating device includes a segmented heating device, the segmented heating device includes a peripheral heater and the air heater, and the accommodation cavity includes a first cavity and a second cavity;
the porous conductive ceramic is provided with the first cavity that is configured to accommodate the first herb segment and is in communication with the air channel; and
the peripheral heater is provided in the outer housing and is located above the porous conductive ceramic, and the peripheral heater is provided with the second cavity that is configured to accommodate the second herb segment and is in communication with the first cavity.

In some embodiments, the air heater includes a first positive pin and a first negative pin, the porous conductive ceramic includes a first end and a second end that are opposite to each other, the first positive pin is electrically connected to the first end, and the first negative pin is electrically connected to the second end.

In some embodiments, an end of the porous conductive ceramic where the first positive pin is connected and another end of the porous conductive ceramic where the first negative pin is connected are at two corners on a diagonal of an axial section of the porous conductive ceramic.

In some embodiments, the peripheral heater includes a second positive pin, a second negative pin, and a dense conductive ceramic that is provided with the second cavity. The dense conductive ceramic includes a third end and a fourth end that are opposite to each other. The second positive pin is electrically connected to the third end, and the second negative pin is electrically connected to the fourth end.

In some embodiments, an end of the dense conductive ceramic where the second positive pin is connected and another end of the dense conductive ceramic where the second negative pin is connected are at two corners on a diagonal of an axial section of the dense conductive ceramic.

In some embodiments, the third end of the dense conductive ceramic and the first end of the porous conductive ceramic are spaced apart or connected in an insulative manner.

In some embodiments, the segmented heating device includes a negative wire, a first positive wire and a second positive wire, and the peripheral heater includes a dense conductive ceramic having the second cavity;
the porous conductive ceramic includes a first end and a second end that are opposite to each other, and the dense conductive ceramic includes a third end and fourth end that are opposite to each other; and
the first end and the third end are connected in an insulative manner, the negative wire is electrically connected to the first end and the third end, the first positive wire is electrically connected to the second end, and the second positive wire is electrically connected to the fourth end.

In some embodiments, the first cavity is a stepped blind hole. The stepped blind hole includes a first hole channel and a second hole channel that is configured to accommodate the first herb segment. The second hole channel is located between the first hole channel and the second cavity, and a diameter of the second hole channel is larger than a diameter of the first hole channel.

In some embodiments, an inner circumferential wall of the second hole channel and/or an outer circumferential wall of the porous conductive ceramic are each covered by a dense sealing layer.

In some embodiments, the air channel is located between an inner wall of the outer housing and an outer wall of the peripheral heater, and air flowing through the air channel flows into the first cavity through an end face of an end of the porous conductive ceramic close to the peripheral heater.

In some embodiments, the outer housing includes a cover. The accommodation cavity includes a third cavity. The cover is provided with the third cavity that is hollow for the herbal product to be inserted. The cover is mounted outside the peripheral heater, and the third cavity is in communication with the second cavity. At least one air channel is provided between an inner wall of the cover and an outer wall of the cover, and a side wall of an end portion of an end of the cover away from the porous conductive ceramic is provided with the at least one first air inlet hole in communication with the air channel.

In some embodiments, a thermal insulation layer is provided between an inner wall of the outer housing and an outer wall of the porous conductive ceramic, and/or between the inner wall of the outer housing and an outer wall of the peripheral heater.

In some embodiments, the thermal insulation layer is made of aerogels, foams, or ceramic fibers.

In some embodiments, the aerosol generating device includes a control board and a power supply that are mounted inside the outer housing, and the control board is electrically connected to the power supply, the porous conductive ceramic and the peripheral heater.

To achieve the above goal, a heat exchanger is further provided according to the present application, and the heat exchanger is the air heater of the aerosol generating device according to any one of the above solutions.

To achieve the above goal, a segmented heating device is further provided according to the present application, which is the segmented heating device of the aerosol generating device according to any one of the above solutions.

Compared with the related art, the present application has the following beneficial effects.

With the technical solutions according to the present application, the porous conductive ceramic with pores distributed everywhere serves as the air heater to heat the air flowing through the porous conductive ceramic, and delivers the heated hot air to the accommodation cavity accommodating the herbal product. In this way, when the user puts the herbal product into the accommodation cavity for use, the herbal product inside the accommodation cavity is heated and atomized by the hot air generated by the porous conductive ceramic. The hot air can quickly permeate into each part of the herbal product, such that the herbal product can be heated fast and evenly as a whole, thereby achieving even heating of the herbal product. Therefore, the taste of the aerosols generated by the heated herbal product is improved, which provides a better smoking experience to the user. Furthermore, smoke can be generated from the herbal product more quickly, which reduces the waiting time of the user and achieves a performance of smoking right after turning on.

### BRIEF DESCRIPTION OF DRAWINGS

For more clearly illustrating embodiments of the present application or the technical solutions to the related technology, drawings describing the embodiments or the related technology will be briefly described hereinafter. Apparently, the drawings in the following description are only some examples of the present application, and for those skilled in the art, other drawings may be obtained based on the structures illustrated in these drawings without any creative efforts.

FIG. 1 is a schematic view showing the principle of the structure of an aerosol generating device according to an embodiment of the present application;

FIG. 2 is a schematic view of an aerosol generating device in use according to an embodiment of the present application;

FIG. 3 is a schematic view showing the structure of an aerosol generating device according to an embodiment of the present application in a case that a first air inlet hole is provided at a lower end face of an outer housing;

FIG. 4 is a schematic view showing the structure of an aerosol generating device according to an embodiment of the present application in a case that a first air inlet hole is provided at an upper end face of an outer housing;

FIG. 5 is a schematic view showing the structure of an aerosol generating device according to an embodiment of the present application in a case that a first air inlet hole is provided on a side wall at an upper end of an outer housing;

FIG. 6 is a schematic view showing connections between a porous conductive ceramic and positive and negative pins according to an embodiment of the present application;

FIG. 7 is a schematic view showing connections between a porous conductive ceramic and positive and negative pins according to another embodiment of the present application;

FIG. 8 is a sectional view of FIG. 7;

FIG. 9 is a schematic view showing the structure of an air heater according to an embodiment of the present application;

FIG. 10 is a schematic view showing the structure of an air heater according to another embodiment of the present application;

FIG. 11 is a schematic view showing the principle of the structure of an aerosol generating device according to an embodiment of the present application having a battery assembly;

FIG. 12 is a schematic view showing the overall structure of an aerosol generating device according to another embodiment of the present application;

FIG. 13 is an exploded view showing the structure of an aerosol generating device according to another embodiment of the present application;

FIG. 14 is a sectional view of an aerosol generating device according to another embodiment of the present application;

FIG. 15 is a schematic view of an aerosol generating device in use according to another embodiment of the present application;

FIG. 16 is a sectional view of a segmented heating device according to an embodiment of the present application;

FIG. 17 is a sectional view of a segmented heating device according to another embodiment of the present application; and

FIG. 18 is a perspective schematic view showing the structure of the segmented heating device shown in FIG. 17.

### REFERENCE NUMERALS

| | | | |
|---|---|---|---|
| 1 | herbal product, | 11 | first herb segment, |
| 12 | second herb segment, | 13 | filter tip, |
| 14 | first position, | 15 | second position, |
| 2 | outer housing, | 21 | air channel, |
| 211 | interlayer, | 22 | accommodation cavity, |
| 221 | first cavity, | 2211 | first hole channel, |
| 2212 | second hole channel, | 222 | second cavity, |
| 223 | third cavity, | 23 | first air inlet hole, |
| 24 | main housing, | 241 | first housing portion, |
| 242 | second housing portion, | 25 | cover, |
| 3 | air heater, | 31 | porous conductive ceramic, |
| 32 | thermal insulation material, | 321 | air outlet hole, |
| 322 | second air inlet hole, | 33 | positive pin, |
| 34 | negative pin, | 35 | first positive pin, |
| 36 | first negative pin, | 4 | peripheral heater, |
| 41 | second positive pin, | 42 | second negative pin, |
| 43 | dense conductive ceramic, | 51 | first positive wire, |
| 52 | second positive wire, | 53 | negative wire, |
| 6 | sealing layer, | 7 | thermal insulation layer, |
| 71 | thermal insulation tube, | 72 | thermal insulation pad, |
| 8 | power supply assembly, | 81 | control board, |
| 82 | power supply. | | |

Realization of purpose, functional characteristics and advantages of the present application will be further described in conjunction with the embodiments and with reference to the accompanying drawings.

### DETAILED DESCRIPTION

Technical solutions according to the embodiments of the present application will be described as follows in conjunction with the accompanying drawings in the embodiments of the present application. It is obvious that the described embodiments are only a part of the embodiments according to the present application, rather than all of the embodiments. All the other embodiments obtained by those skilled in the art based on the embodiments in the present application without any creative work belong to the scope of protection of the present application.

It should be noted that, if there are directional indications (such as “up,” “down,” “left,” “right,” “front,” “rear,” . . . ) in the embodiments of the present application, the directional indications are only used to explain the relative positional relationship, movement, and so on, between the components in a particular posture (as shown in the drawings). If the particular posture changes, the directional indications also change accordingly.

In addition, when a component is said to be “fixed” to another component, it may be directly fixed onto the other component or there may be an intermediate component present at the same time. When a component is said to be “connected” to another component, it may be directly connected to the other component or there may be an intermediate component present at the same time.

Moreover, if there are descriptions such as “first,” “second” and the like in the embodiments of the present application, the descriptions such as “first,” “second” and the like are only for purpose of description, and should not be interpreted as indicating or implying relative importance or implying the number of the indicated technical features. In this way, the feature defined by the terms “first,” “second” may explicitly or implicitly include at least one such feature. In addition, the meaning of “and/or” appearing herein includes three parallel solutions, taking “A and/or B” as an example, including a solution A, or a solution B, or a solution that both A and B satisfy at the same time. Besides, the technical solutions among the various embodiments can be combined with each other, but it must be based on the realization of those skilled in the art. When the combination of technical solutions is contradictory or cannot be realized, it should be considered that such a combination of technical solutions does not exist, nor is it within the protection scope of the present application.

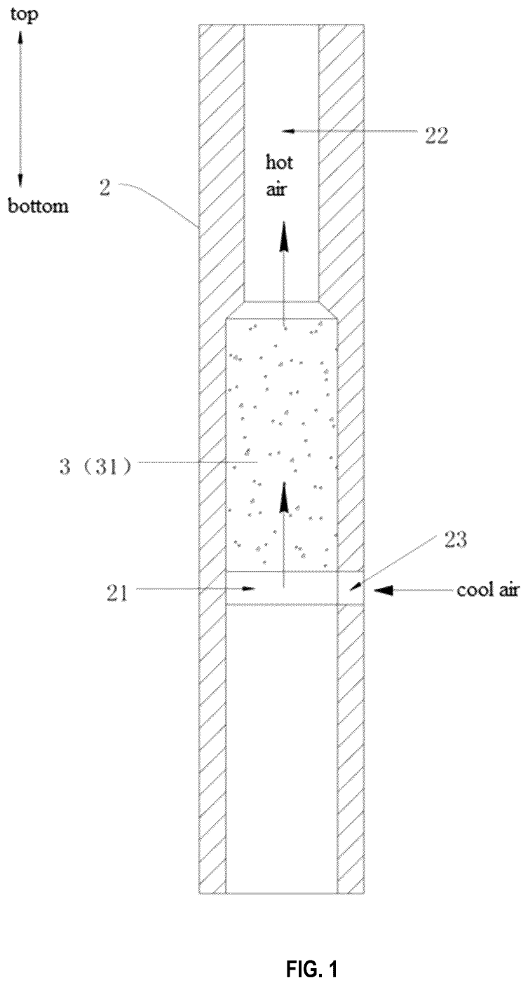

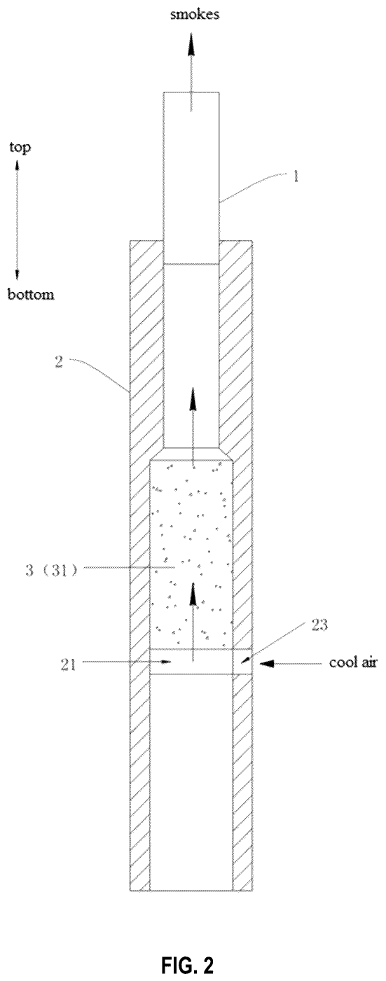

FIG. 1 is a schematic view showing the principle of the structure of an aerosol generating device according to an embodiment of the present application. FIG. 2 is a schematic view of an aerosol generating device in use according to an embodiment of the present application.

Referring to FIG. 1 and FIG. 2, an aerosol generating device configured for heating an herbal product 1 is provided according to an embodiment of the present application. The aerosol generating device includes an outer housing 2 and an air heater 3. An accommodation cavity 22 that accommodates the herbal product 1 and an air channel 21 is provided inside the outer housing 2. The outer housing 2 is provided with at least one first air inlet hole 23, and air from an exterior enters the air channel 21 through the first air inlet hole 23. That is, the first air inlet hole 23 is in communication with the exterior and the air channel 21. The air heater 3 includes a porous conductive ceramic 31 mounted inside the outer housing 2, and at least a part of the porous conductive ceramic 31 is located between the accommodation cavity 22 and the air channel 2. Multiple pores for the air to pass through are distributed in the whole porous conductive ceramic 31. The porous conductive ceramic 31 is configured to heat the air that flows through the porous conductive ceramic 31 and enters the accommodation cavity 22, so that the heated air can heat the herbal product 1.

In the present embodiment, specifically, the above herbal product 1 may be low-temperature non-combusted tobacco (a cigarette, for example), or may be of other types of aerosol generating products, such as tea plant leaves, tobacco leaves, tobacco shreds, cannabis and the like, which may be selected according to actual needs of the user, and is not specifically limited in the present embodiment. It should be noted that, the low-temperature non-combusted tobacco refers to an aerosol generating product made of materials such as tobacco shreds, tobacco pellets, plant fragments, tobacco flavorings, propylene glycol and the like. The low-temperature non-combusted tobacco is also called a low-temperature non-combusted cigarette due to its rod-like shape (a cylindrical shape, for example). When the low-temperature non-combusted tobacco is heated at a low temperature, nicotine and other flavoring substances therein are volatilized to generate atomized steams without solid particles. The low-temperature non-combusted process is actually a low-temperature dry distillation process, whose heating temperature ranges from 200° C. to 400° C. The low temperature herein refers to a temperature at which the herbal product 1 can generate aerosols without combustion, for example, a temperature between 200° C. and 400° C. In addition, it should be noted that, the shape of the herbal product 1 may be of a certain shape (a rod-shaped cigarette, for example) or may not be of a certain shape (shapeless tobacco shreds, for example) in actual use, which is not specifically limited in the present embodiment.

In the present embodiment, the porous conductive ceramic 31 is a conductive ceramic material that is sintered at high temperature, and has a huge number of pore structures in communication with each other and in communication with a surface of the material. In actual implementations, the porous conductive ceramic 31 may be made of a mixture of conductive powder and at least one of silicon carbide, silicon dioxide, aluminium oxide and zirconium dioxide, and the conductive powder may be made of at least one of titanium nitride, zirconium nitride, titanium carbonitride, titanium carbide, zirconium carbide, thallium carbide, hafnium carbide, titanium diboride, zirconium diboride, thallium boride, hafnium diboride, molybdenum disilicide and tungsten carbide. In addition, the shape of the porous conductive ceramic 31 may be regular or irregular in actual implementations. Optionally, the porous conductive ceramic 31 may be of a cylindrical shape, a conical shape, a helical shape, a trapezoidal shape, a dumbbell shape, a concave shape, a spherical shape or the like, as long as the porous conductive ceramic 31 can heat the air and deliver the heated air to the accommodation cavity 22 accommodating the herbal product 1. The implementation is not limited in the present embodiment. Moreover, when being mounted inside the outer housing 2, the porous conductive ceramic 31 may be vertically and coaxially arranged inside the outer housing 2. Alternatively, the porous conductive ceramic 31 may be transversely arranged inside the outer housing 2 and there is an angle between an axial direction of the porous conductive ceramic 31 and an axial direction of the outer housing 2, as long as the porous conductive ceramic 31 can heat the air and deliver the heated air to the accommodation cavity 22 accommodating the herbal product 1. The implementation is not limited in the present embodiment.

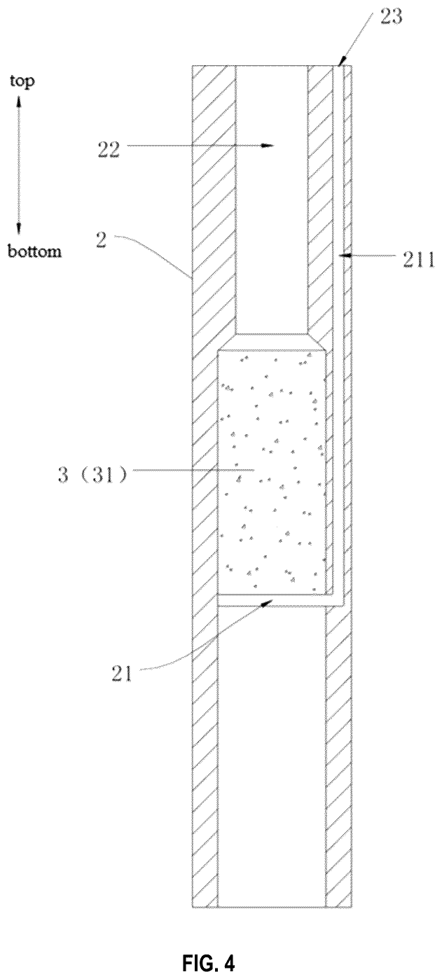

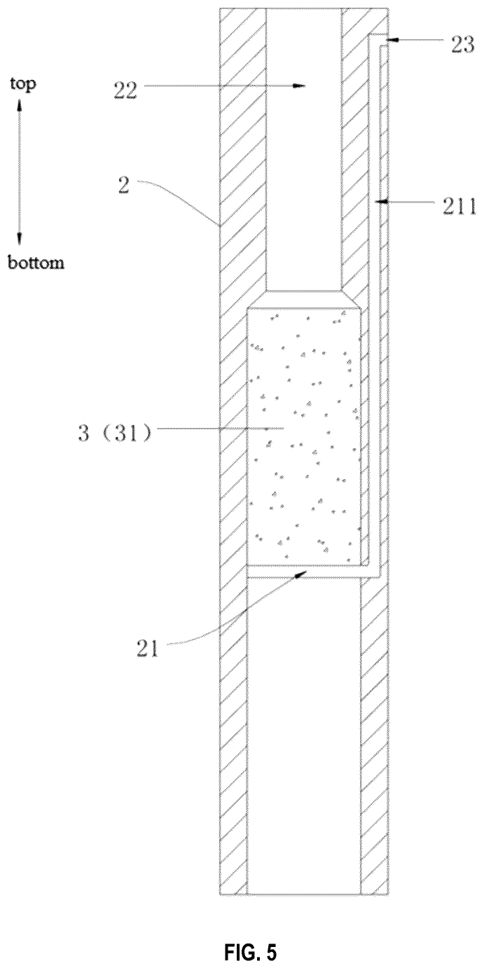

FIG. 4 is a schematic view showing the structure of an aerosol generating device according to an embodiment of the present application in a case that a first air inlet hole is provided at an upper end face of an outer housing. FIG. 5 is a schematic view showing the structure of an aerosol generating device according to an embodiment of the present application in a case that a first air inlet hole is provided on a side wall at an upper end of an outer housing.

In the present embodiment, the air channel 21 may be formed by an internal space of the outer housing 2 in actual implementations. For example, as shown in FIG. 4, an interlayer 211 having a cavity is provided in a side wall of the outer housing 2, and the first air inlet hole 23 is provided at a top end of the interlayer 211 at an end of the outer housing 2 close to the accommodation cavity 22. As another example, as shown in FIG. 5, an interlayer 211 having a cavity is provided in the side wall of the outer housing 2, and the first air inlet hole 23 is provided on the side wall of the outer housing 2 at the end of the outer housing 2 close to the accommodation cavity 22. Certainly, the air channel 21 may be a component of a tube type that is independent from the outer housing 2, as long as the air from the exterior can flow into the porous conductive ceramic 31 through the air channel 21. The implementation is not specifically limited in the present embodiment. It may be understood that, when the air channel 21 is formed by the internal space of the outer housing 2, the first air inlet hole 23 may be regarded as an air inlet end of the air channel 21. Besides, when the air channel 21 is arranged, the air channel 21 may be provided as close as possible to an outer surface of the porous conductive ceramic. For example, if the air channel 21 is an independent tube-typed component, an outer wall of the air channel 21 may tightly contact an outer side wall of the porous conductive ceramic. In this way, when the porous conductive ceramic 31 is powered and generates heat, cool air flowing into the air channel 21 from the exterior can be preheated by excess heat diffusing from the outer surface of the porous conductive ceramic 31, thereby increasing the utilization rate of the heat generated by the porous conductive ceramic 31. Thus, the porous conductive ceramic 31 can heat the air flowing from the air channel 21 faster to a required temperature (between 200° C. and 400° C., for example), which helps the herbal product 1 inside the accommodation cavity 22 to produce smoke faster.

In the present embodiment, the aerosol generating device further includes a power supply part in some actual applications. In specific use, the porous conductive ceramic 31 is electrically connected to the power supply part of the aerosol generating device by wires or the like, such that after being powered, the porous conductive ceramic 31 can heat the air flowing from the exterior and deliver the heated air to the accommodation cavity 22 to heat the herbal product 1 inside the accommodation cavity 22 evenly.

In the technical solutions according to the present embodiment, based on the above structural designs, the porous conductive ceramic 31 with pores distributed everywhere serves as the air heater to heat the air flowing through the porous conductive ceramic 31, and delivers the heated hot air to the accommodation cavity 22 accommodating the herbal product 1. In this way, when the user puts the herbal product 1 into the accommodation cavity 22 for use, the herbal product 1 inside the accommodation cavity 22 is heated and atomized by the hot air generated by the porous conductive ceramic 31. The hot air can quickly permeate into each part of the herbal product 1, such that the whole herbal product 1 can be heated evenly, thereby achieving even heating for the herbal product 1. Therefore, the taste of the aerosols produced from the heated tobacco is improved, which provides better smoking experience to the user. Furthermore, smoke can be produced by the tobacco more quickly, which reduces the waiting time of the user, and achieves a performance of smoking right after turning on.

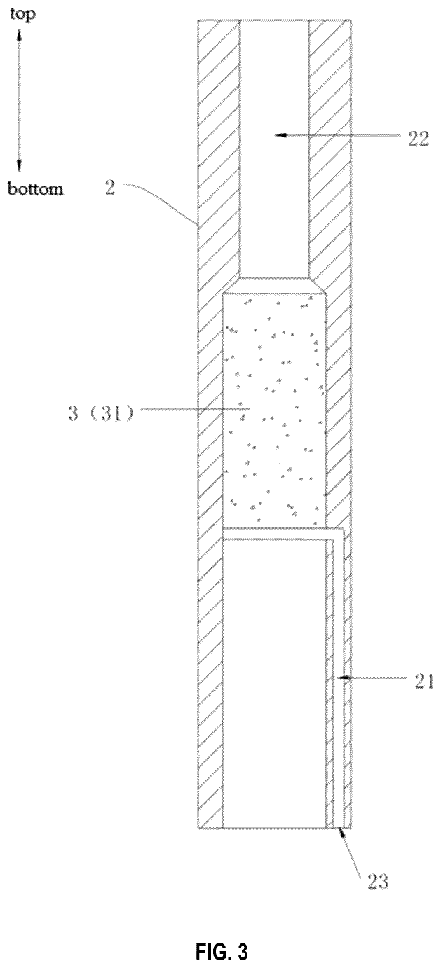

FIG. 3 is a schematic view showing the structure of an aerosol generating device according to an embodiment of the present application in a case that a first air inlet hole is provided at a lower end face of an outer housing.

In some embodiments, referring to FIG. 3, in an exemplary embodiment of the present application, the first air inlet hole 23 is provided at an end portion of an end of the outer housing 2 away from the accommodation cavity 22. Compared with a solution where the first air inlet hole 23 is provided at a middle portion of the outer side wall of the outer housing 2 or other positions where the user is used to holding the device by hand, the present arrangement reduces a risk brought by a situation where the air inlet hole is blocked by a hand of the user during smoking, which makes the air from the exterior not able to enter the porous conductive ceramic 31 smoothly and to be heated continuously.

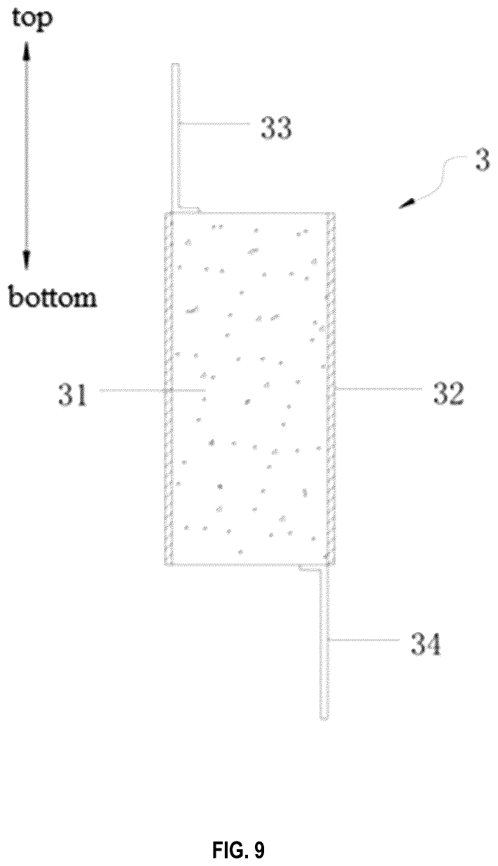

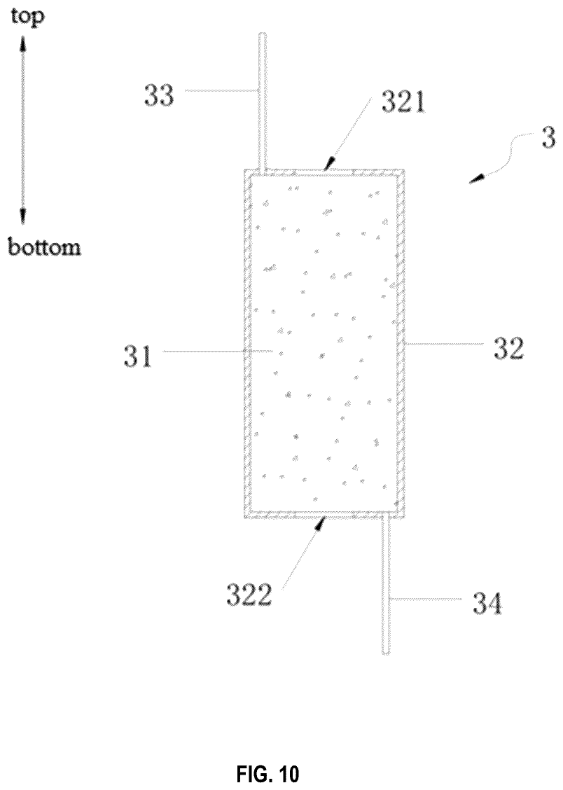

FIG. 9 is a schematic view showing the structure of an air heater according to an embodiment of the present application. FIG. 10 is a schematic view showing the structure of an air heater according to another embodiment of the present application.

In some embodiments, referring to FIG. 1, FIG. 9 and FIG. 10, in an exemplary embodiment of the present application, at least one layer of a thermal insulation material 32 is provided outside the outer surface of the porous conductive ceramic 31, and the thermal insulation material 32 is provided with at least one second air inlet hole 322 in communication with the air channel 21 and at least one air outlet hole 321 in communication with the accommodation cavity 22. With this arrangement, the air from the exterior can smoothly enter the porous conductive ceramic 31 to be heated, and the heated air can be smoothly delivered to the accommodation cavity 22 to heat the herbal product 1 evenly. Furthermore, heat loss of the porous conductive ceramic 31 when being powered and performing heating can be reduced, thereby increasing heating efficiency of the porous conductive ceramic 31. In actual implementations, the thermal insulation material 32 is preferably made of an insulative, air proof, heat resisting and non-toxic material. For example, the thermal insulation material 32 may be a dense ceramic housing sleeved outside the porous conductive ceramic 31, or may be a ceramic glaze layer coated on the outer surface of the porous conductive ceramic 31, or certainly may be other types of thermal insulation materials, as long as the using requirement is satisfied. The implementation is not specifically limited in the present embodiment.

In some embodiments, referring to FIG. 1, FIG. 9 and FIG. 10, in an exemplary embodiment of the present application, the second air inlet hole 322 is provided on the thermal insulation material 32 on the porous conductive ceramic 31 and is away from the accommodation cavity 22, and the air outlet hole 321 is provided on the thermal insulation material 32 on the porous conductive ceramic 31 and is close to the accommodation cavity 22. In actual implementations, the second air inlet hole 322 may be provided on the thermal insulation material 32 on a bottom face of the porous conductive ceramic 31, or may be provided on the thermal insulation material 32 on the side wall at a bottom end of the porous conductive ceramic 31. The air outlet hole 321 may be provided on the thermal insulation material 32 on a top face of the porous conductive ceramic, or may be provided on the thermal insulation material 32 on the side wall at a top end of the porous conductive ceramic 31. With this arrangement, the air from the exterior can sufficiently flow through the porous conductive ceramic 31 to be heated, which improves the utilization rate of the heat and the amount of hot air generated by the porous conductive ceramic 31, and allows the herbal product 1 in the accommodation cavity 22 to produce smoke faster.

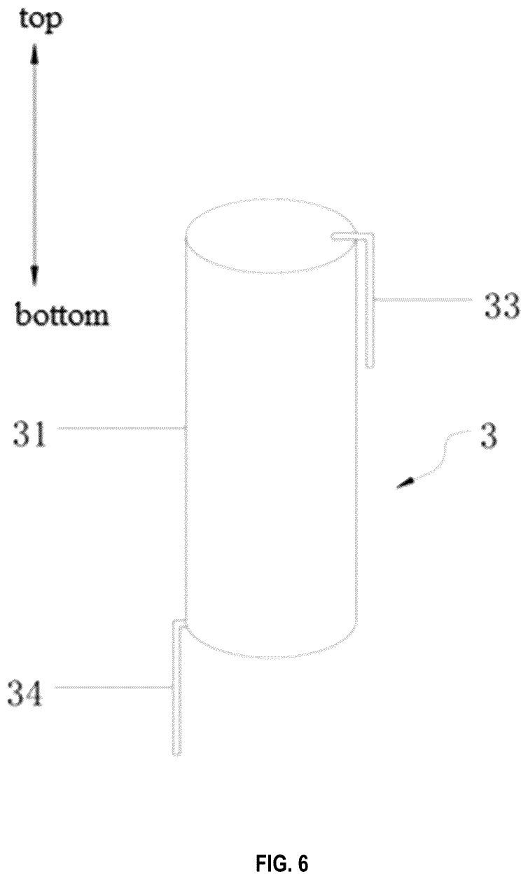

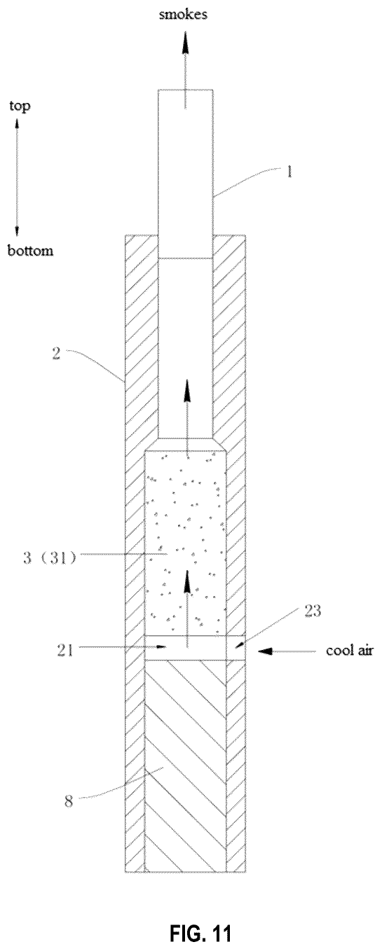

FIG. 6 is a schematic view showing connections between a porous conductive ceramic and positive and negative pins according to an embodiment of the present application. FIG. 11 is a schematic view showing the principle of the structure of an aerosol generating device according to an embodiment of the present application having a battery assembly.

In some embodiments, referring to FIG. 1, FIG. 6 and FIG. 11, in an exemplary embodiment of the present application, the air heater 3 includes a positive pin 33 and a negative pin 34, and the porous conductive ceramic 31 is electrically connected to the positive pin 33 and the negative pin 34. Specifically, the porous conductive ceramic 31 may be electrically connected to the positive pin 33 and the negative pin 34 by welding or other means. In this way, the positive pin 33 and the negative pin 34 are provided on the porous conductive ceramic 31, which facilitates electrical connection between the porous conductive ceramic 31 and the power supply part of the aerosol generating device in some specific applications.

In some embodiments, referring to FIG. 1 and FIG. 6, in an exemplary embodiment of the present application, the porous conductive ceramic 31 includes a first end and a second end that are opposite to each other. The positive pin 33 is electrically connected to the first end of the porous conductive ceramic 31, and the negative pin 34 is electrically connected to the second end of the porous conductive ceramic 31. Illustratively, the positive pin 33 is electrically connected to an end face of the first end of the porous conductive ceramic 31, and the negative pin 34 is electrically connected to an end face of the second end of the porous conductive ceramic 31. In this way, the positive pin and the negative pin are arranged at the two ends of the porous conductive ceramic 31 away from each other, which prevents the positive pin 33 and the negative pin 34 from being short-circuited for being too close to each other, thereby ensuring the porous conductive ceramic 31 to generate heat normally without short circuit when being powered.

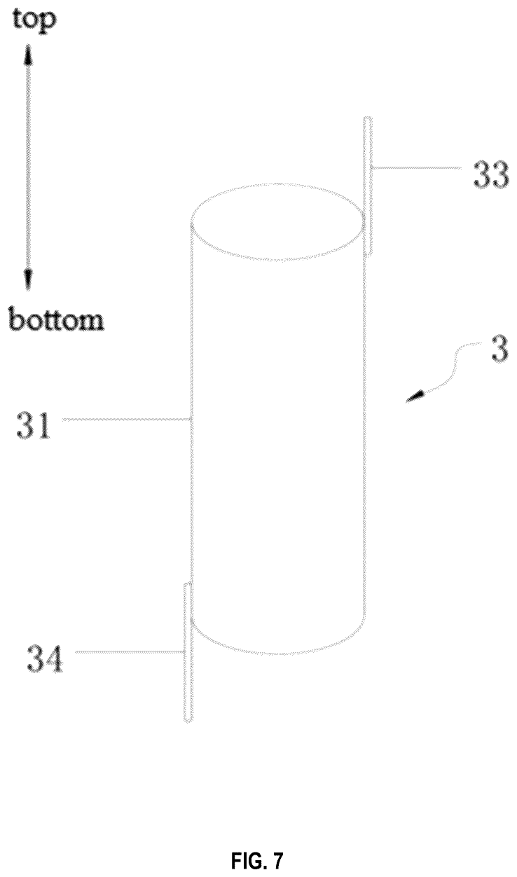

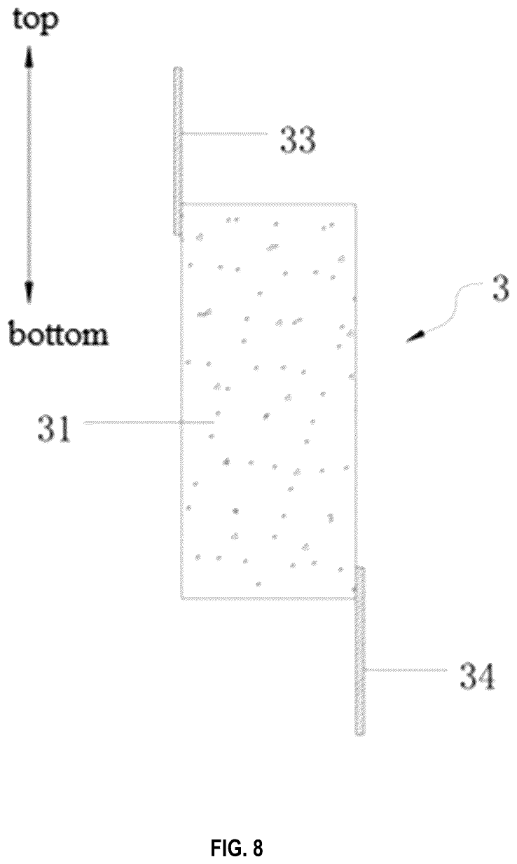

FIG. 7 is a schematic view showing connections between a porous conductive ceramic and positive and negative pins according to another embodiment of the present application. FIG. 8 is a sectional view of FIG. 7.

In some embodiments, referring to FIG. 1, FIG. 7, and FIG. 8, in another exemplary embodiment of the present application, the porous conductive ceramic 31 includes a first end and a second end that are opposite to each other. The positive pin 33 is provided at an outer side face of the porous conductive ceramic 31 and is close to the first end. The negative pin 34 is provided at the outer side face of the porous conductive ceramic 31 and is close to the second end. This arrangement also prevents the positive pin 33 and the negative pin 34 from being short-circuited for being too close to each other, thereby ensuring the porous conductive ceramic 31 to generate heat normally without short circuit when being powered. In actual implementations, preferably, a position on the porous conductive ceramic 31 where the positive pin 33 is provided and a position on the porous conductive ceramic 31 where the negative pin 34 is provided are spaced apart along a circumferential direction of the porous conductive ceramic 31. In some embodiments, an end of the porous conductive ceramic 31 where the positive pin 33 is connected and another end of the porous conductive ceramic 31 where the negative pin 34 is connected are at two corners on a diagonal of an axial section of the porous conductive ceramic 31. In this way, when the porous conductive ceramic 31 is powered, a current can flow through the whole porous conductive ceramic 31 more sufficiently, and the porous conductive ceramic 31 generates heat better when being powered.

In some embodiments, it is found from research that, when a porosity of the porous conductive ceramic 31 is less than 30%, which indicates less pore structures and more solid structures in the porous conductive ceramic 31, the ventilation performance of the porous conductive ceramic 31 is poor. As a result, the user finds it tough to smoke, and has a bad smoking experience. Furthermore, the heat capacity of the porous conductive ceramic 31 is increased due to the many solid structures, which causes an increase of power consumption of the porous conductive ceramic 31 during operation. When the porosity of the porous conductive ceramic 31 is more than 70%, which indicates more pore structures and less solid structures in the porous conductive ceramic 31, the actual area in the porous conductive ceramic 31 that can heat the air is decreased. As a result, the heating efficiency of the porous conductive ceramic 31 is decreased. Based on this discovery, in an exemplary embodiment of the present application, the porosity of the porous conductive ceramic 31 is preferably between 30% and 70%. It should be noted that, those skilled in the art would understand that, the porosity of the porous conductive ceramic 31 refers to a ratio of the volume of the pores in the porous conductive ceramic to the total volume of the porous conductive ceramic in the natural state expressed in percentage.

In some embodiments, according to research, when a pore-opening degree of the porous conductive ceramic 31 is less than 90%, the ventilation performance of the porous conductive ceramic 31 is poor as well, which also makes the user find it tough to smoke and have a bad smoking experience. Based on this discovery, in an exemplary embodiment of the present application, the pore-opening degree of the porous conductive ceramic 31 is preferably larger than or equal to 90%. It should be noted that, those skilled in the art would understand that, the pore-opening degree of the porous conductive ceramic 31 refers to a ratio of the number of through pores to the total number of the pore structures in the porous conductive ceramic expressed in percentage, where the total number of the pore structures is equal to a sum of the number of the through pores and the number of closed pores.

In some embodiments, referring to FIGS. 1 to 11, in an exemplary embodiment of the present application, the above aerosol generating device includes a power supply assembly 8, which is the power supply part of the aerosol generating device. The power supply assembly 8 is mounted inside the outer housing 2, and is electrically connected to the porous conductive ceramic 31. Specifically, the power supply assembly 8 includes a power supply (not shown in the figures) and a control board (not shown in the figures). The control board is electrically connected to the power supply and the porous conductive ceramic 31, and the control board is configured to control the operation of the porous conductive ceramic 31. After the herbal product 1 is put into the accommodation cavity 22, the control board controls the power supply to supply power to the porous conductive ceramic 31, such that the porous conductive ceramic 31 can heat the air flowing through the porous conductive ceramic 31. The heated hot air heats and atomizes the herbal product 1 to produce aerosols for the user to smoke. The power supply may be a lithium battery or other batteries, which is configured to supply power to the porous conductive ceramic 31, thus the porous conductive ceramic 31 can be powered to generate heat.

Correspondingly, referring to FIGS. 1 to 11, a heat exchanger for heating the herbal product 1 is further provided according to an embodiment of the present application, and the heat exchanger is the air heater 3 of the aerosol generating device according to any one of the above embodiments.

In the present embodiment, specifically, the heat exchanger is applied to an aerosol generating device. The aerosol generating device includes the outer housing 2. A mounting cavity that accommodates the heat exchanger and an accommodation cavity 22 that accommodates the herbal product 1 and is in communication with the mounting cavity are provided inside the outer housing 2. In actual use, the heat exchanger is mounted inside the mounting cavity of the aerosol generating device, and is electrically connected to the power supply part of the aerosol generating device by wires or the like, such that the heat exchanger can heat the air flowing from the exterior and deliver the heated air to the accommodation cavity 22 to evenly heat the herbal product 1 inside the accommodation cavity 22 after being powered.

In the technical solutions according to the present embodiment, the porous conductive ceramic 31 with pores distributed everywhere serves as the heat exchanger. When the heat exchanger is applied to the aerosol generating device, the porous conductive ceramic 31 can heat the air flowing through the porous conductive ceramic 31, and deliver the heated hot air to the accommodation cavity 22 accommodating the herbal product 1. In this way, when the user puts the herbal product 1 into the accommodation cavity 22 for use, the herbal product 1 inside the accommodation cavity 22 is heated and atomized by the hot air generated by the porous conductive ceramic 31. The hot air can permeate into each part of the herbal product 1, such that the whole herbal product 1 can be heated evenly, thereby achieving an even heating for the herbal product 1. Therefore, the taste of the aerosols being produced is improved, which provides a better smoking experience to the user. In the present embodiment, it should be noted that, other contents of the heat exchanger in this embodiment may refer to the above descriptions in the embodiments of the aerosol generating device, which is not described in detail herein.

In actual use of the aerosol generating device according to the above embodiments, it has been discovered that, compared with a conventional central heating method (referring to the related descriptions in the background for a detailed process of the central heating method), the air heating method that heats the herbal product 1 using hot air generated by the porous conductive ceramic 31 can perform heating evenly. However, since the hot air flows from bottom to top, if the herbal product 1 to be heated is long (in other words, the herbal product 1 to be heated has a large thickness or height), there is a temperature gradient in the heated herbal product 1 that decreases from bottom to top. Thus, in order to fully atomize the upper half of the herbal product 1, the temperature of the hot air is required to be increased continually, i.e., the operation temperature of the porous conductive ceramic 31 during heating is required to be increased. As a result, the lower half of the herbal product 1 may be overheated and carbonized. In addition, both the central heating method and the air heating method perform a central heating for the whole herbal product 1, thus they have a common problem that, volatile substances (such as nicotine and flavoring substances) in the herbal product 1 may be released intensively in the first half of the overall smoking process, which brings the user a strong taste or even makes the user choke, while in the second half of the smoking process, the volatile substances may be decrease fast, which brings the user a mild and poor taste. For example, suppose that the herbal product 1 can be smoked by 15 puffs in a whole process, the volatile substances in the herbal product 1 are usually intensively released in the first 7 puffs, and decrease faster in the remaining puffs. When the whole herbal product 1 is about to be consumed, almost no volatile substances are released. Therefore, there is a problem that the taste is not well kept. Regarding the above problem, improvements are made in further embodiments of the present application based on the aerosol generating device according to the above embodiments, the detailed contents of which are described in the following related embodiments.

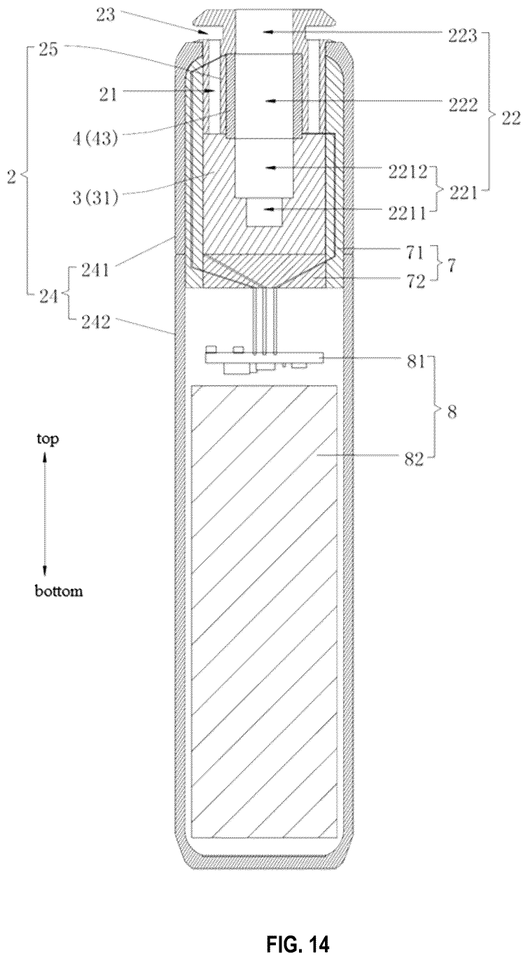

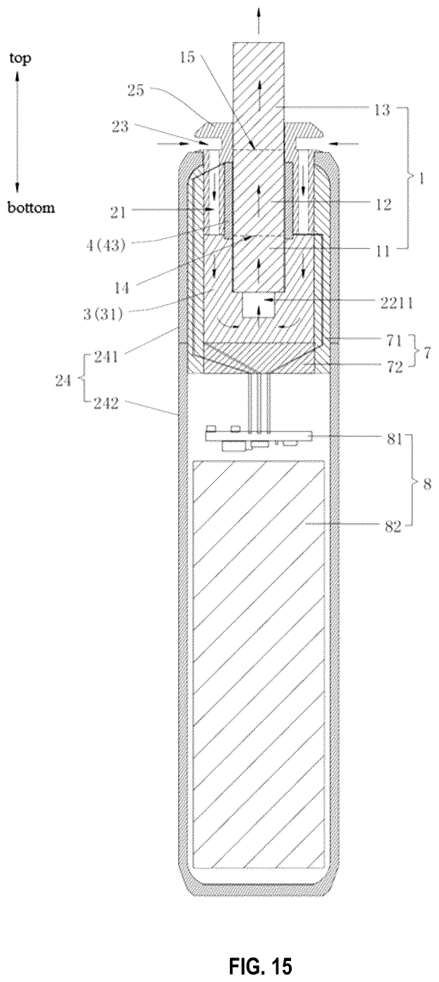

FIG. 14 is a sectional view of an aerosol generating device according to another embodiment of the present application. FIG. 15 is a schematic view of an aerosol generating device in use according to another embodiment of the present application.

In some embodiments, referring to FIG. 14 and FIG. 15, in an exemplary embodiment of the present application, in a case where the herbal product to be heated is relatively long, the herbal product includes a first herb segment 11 and a second herb segment 12 that are connected as a whole. An aerosol generating device according to the present embodiment includes a segmented heating device, and the segmented heating device includes a peripheral heater 4 and the air heater 3 according to the above embodiments that includes the porous conductive ceramic 31. The above accommodation cavity 22 includes a first cavity 221 and a second cavity 222. The porous conductive ceramic 31 in the present embodiment is provided with the first cavity 221 that accommodates the first herb segment 11 and is in communication with the air channel 21. The porous conductive ceramic 31 is configured to heat air that flows through the air channel 21 and enters the first cavity 221 up to a first temperature, and the heated air further heats the first herb segment 11 to generate aerosols in an atomized state. The peripheral heater 4 is provided inside the outer housing 2 and is located above the porous conductive ceramic 31, and the peripheral heater 4 is provided with the second cavity 222 that accommodates the second herb segment 12 and is in communication with the first cavity 221. The peripheral heater 4 may be configured to directly heat the second herb segment 12 from the room temperature to the atomized state to generate aerosols, or may be configured to heat and atomize the second herb segment 12 after the hot air heated by the porous conductive ceramic 31 preheats the second herb segment 12 to a certain preheating temperature or a threshold before atomization, or may be configured to preheat the second herb segment 12 from the room temperature to a certain temperature and then heat the second herb segment 12 to the atomized state to generate aerosols. The use of the peripheral heater 4 is not specifically limited herein.

In the present embodiment, in actual implementations, the above herbal product specifically includes a filter tip 13, and the filter tip 13, the second herb segment 12 and the first herb segment 11 are connected in sequence into a whole.

In the present embodiment, the above first temperature refers to an atomization temperature that makes the first herb segment 11 produce aerosols without combustion. The atomization temperature varies with types of the herbal product, and is usually between 200° C. and 400° C.

In the present embodiment, in actual implementations, the peripheral heater 4 may be a heating tube based on a metal resistor. Specifically, the heating tube based on the metal resistor includes a hollow tube body and a metal resistor attached to the tube body. The metal resistor may be of a heating sheet, a heating mesh or a heating wire. The tube body may be made of a metal or an insulating ceramic, and the metal resistor may be attached on an inner surface or an outer surface of the tube body by printing, coating, inlaying or other methods. During operation, heat generated by the metal resistor after being powered can be used to perform peripheral heating on the second herb segment 12 inside the second cavity 222.

The operation principles of the aerosol generating device according to the present embodiment are as follows.

Before use, the herbal product is inserted into the outer housing 2, such that most of the filter tip 13 is exposed outside. A part of the herbal product inside the first cavity 221 is referred to as the first herb segment 11, and another part of the herbal product inside the second cavity 222 is referred to as the second herb segment 12. As shown in FIG. 15, yet another part of the herbal product from a second position 15 to an end of the herbal product exposed outside the aerosol generating device is referred to as the filter tip 13, the part of the herbal product from a first position 14 to the other end of the herbal product away from the filter tip 13 is referred to as the first herb segment 11, and the another part of the herbal product between the first position 14 and the second position 15 is referred to as the second herb segment 12. It may be understood that, in actual use, to prevent the filter tip from being scorched, the second herb segment 12 is not completely put into the second cavity 222, instead, a little part of the second herb segment 12 extends out of the second cavity 222, and the little part of the second herb segment 12 has a length ranging from 2 mm to 3 mm. In use, in the first half of the whole smoking process, the air heater 3 is turned on to heat the air that flows through the air channel 21 and enters into the first cavity 221 to form hot air. The hot air flows through the first herb segment 11, heats and atomizes the first herb segment 11, such that volatile substances in the first herb segment 11 are released to form aerosols that can be smoked by the user. When the hot air heats and atomizes the first herb segment 11, the temperature of the hot air gradually decreases along a direction from the first herb segment 11 to the second herb segment 12 (there is usually a temperature decrease of 20° C. to 50° C.). Therefore, when the hot air flows through the second herb segment 12, the hot air with a decreased temperature can only atomize a small part of the second herb segment 12 or even cannot atomize the second herb segment 12 at all. In the second half of the smoking process, the volatile substances in the first herb segment 11 are almost depleted. To keep supplying aerosols for the user to smoke, the air heater 3 is turned off and the peripheral heater 4 is turned on. The peripheral heater 4 heats and atomizes the second herb segment 12, such that volatile substances in the second herb segment 12 are released to form aerosols for the user to smoke.

In the technical solutions according to the present embodiment, with the structural design of segmented heating by combining the air heater 3 and the peripheral heater 4, the air heater 3 can not only preheat an inner wall of the first cavity 221 to preheat the lower half of the herbal product 1, i.e., the first herb segment 11, but also heat the air to allow the hot air to heat and atomize the first herb segment 11, while the upper half of the herbal product 1, i.e., the second herb segment 12 is preheated, heated and atomized by the peripheral heater 4. In this way, different parts of the herbal product 1 can be heated and atomized by the segmented heating method. Only volatile substances in a part of the herbal product that is heated to the atomization temperature are volatilized, while the other part of the herbal product that is not heated to the atomization temperature may not be volatilized. Therefore, different parts of the herbal product 1 are atomized at different stages during the process of the herbal product 1 being smoked. In this way, the uniformity of the volatilization amount of the volatile substances such as nicotine, flavorings and the like at different stages can be controlled, such that the volatile substances in the whole herbal product 1 can be slowly and gradually volatilized. Thus, the volatilization amount of the volatile substances at different stages are balanced, such that the herbal product 1 can release relatively sufficient volatile substances even if it is about to be finished, thereby keeping the taste during the entire smoking process of the user. In addition, when the hot air generated by the air heater 3 heats and atomizes the first herb segment 11, although the temperature of the hot air gradually decreases along the direction from the first herb segment 11 to the second herb segment 12 and the hot air cannot sufficiently atomize the second herb segment 12, the hot air with a decreased temperature can still preheat the second herb segment 12. Thus, when the peripheral heater 4 heats and atomizes the second herb segment 12, the second herb segment 12 only needs to absorb a small amount of heat to be fully atomized and produce abundant aerosols. In this way, the heating temperature of the hot air does not need to be increased or only needs to be increased slightly to evenly heat and fully atomize the upper half of the herbal product 1, thereby effectively preventing the herbal product 1 from being carbonized due to local overheating. In the present embodiment, it may be understood that, the hot air forms hot airflow and flows into the herbal product 1 only when the user smokes.

In the present embodiment, it may be understood that, in some actual applications, as described hereinabove, the air heater 3 may preheat the first herb segment 11 to a second temperature. Specifically, during operation of the air heater 3, the inner wall of the first cavity 221 generates some heat, and the inner wall of the first cavity 221 contacts the first herb segment 11 to preheat the first herb segment 11. It should be noted that, the air heater 3 may preheat only the first herb segment 11 or may preheat the second herb segment 12 when heating and atomizing the first herb segment 11. In addition, the peripheral heater 4 may preheat the second herb segment 12 to a third temperature, where the second temperature and the third temperature are both lower than the first temperature. As described hereinabove, the first temperature is the atomization temperature at which herbal products such as low-temperature non-combusted tobacco and cannabis are heated to produce aerosols. In an embodiment, the first temperature may be between 200° C. and 400° C., the second temperature may be between 100° C. and 290° C., and the third temperature may be between 100° C. and 290° C. For example, suppose that the atomization temperature of the herbal product is 320° C., the first temperature is 320° C., the second temperature may be 240° C., and the third temperature may also be 240° C. The using principles of the aerosol generating device in this case are as follows.

The aerosol generating device is at a preheating stage at first when being operated. That is, the air heater 3 or both the air heater 3 and the peripheral heater 4 are turned on to preheat the first herb segment 11 and the second herb segment 12. During the preheating process, the air heater 3 may work at the second temperature, and the peripheral heater 4 may work at the third temperature. It may be understood that, at the preheating stage of the aerosol generating device, since the user does not smoke, hot airflow cannot form due to lack of smoking action of the user even if the air heater 3 heats the air. Therefore, the hot air cannot preheat the herbal product at the preheating stage of the aerosol generating device. After preheating is finished, a first stage of the smoking of the user, i.e., the first half of the whole smoking process is entered. The air heater 3 is turned on to heat and atomize the first herb segment 11, while the peripheral heater 4 may be not operated or may preheat the second herb segment 12. At the first stage, the air heater 3 works at the first temperature. That is, at the first stage, the air heater 3 heats the first herb segment 11 to the first temperature, such that the first herb segment 11 is atomized and produces smoke. After the first stage is finished, a second stage of the smoking of the user, i.e., the second half of the whole smoking process is entered. The peripheral heater 4 is turned on to heat and atomize the second herb segment 12, while the air heater 3 may be not operated or may be operated to preheat. Preferably, during the second half of the whole smoking process, the air heater 3 is operated to preheat, such that the air flowing through the second herb segment 12 is hot rather than cool when the user smokes. In this way, the second herb segment 12 can produce smoke faster, and reduce the waiting time of the user, thereby improving the using experience of the user. It should be noted that the air heater 3 works at a lower temperature than the first temperature in the preheating process. For example, suppose that the first temperature is 310° C., the air heater 3 may work at 120° C., 150° C., 200° C., 210° C., 220° C. or the like in the preheating process. At the second stage, the peripheral heater 4 works at the first temperature. That is, at the second state, the peripheral heater 4 heats the second herb segment 12 to the second temperature, such that the second herb segment 12 is atomized and produces smoke. After the second stage is finished, the aerosol generating device is turned off. In this way, before being heated and atomized, the first herb segment 11 and the second herb segment 12 are preheated, such that the first herb segment 11 and the second herb segment 12 can be quickly heated to the atomization temperature at which they can produce aerosols when being heated and atomized. Thus, the first herb segment 11 and the second herb segment 12 can produce smoke fast and reduce the waiting time of the user, which improves the using experience of the user.

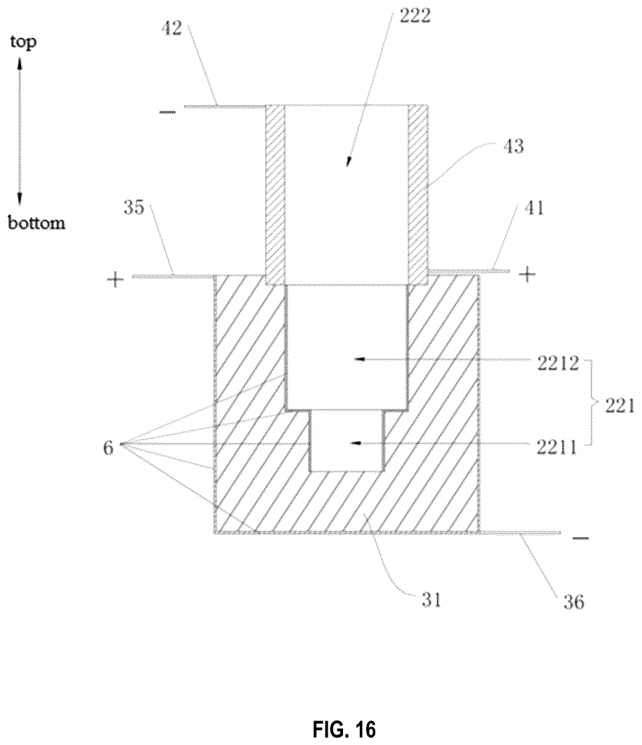

FIG. 16 is a sectional view of a segmented heating device according to an embodiment of the present application.

In some embodiments, in some specific embodiments, referring to FIG. 15 and FIG. 16, apart from the porous conductive ceramic 31 having the first cavity 221, the air heater 3 further includes a first positive pin 35 and a first negative pin 36. The porous conductive ceramic 31 includes a first end and a second end that are opposite to each other. The first positive pin 35 is electrically connected to the first end of the porous conductive ceramic 31 (i.e., an upper end of the porous conductive ceramic 31), and the first negative pin 36 is electrically connected to the second end of the porous conductive ceramic 31 (i.e., a lower end of the porous conductive ceramic 31). It may be understood that, in actual implementations, an end portion of the first positive pin 35 may be electrically connected to an end face of the first end of the porous conductive ceramic 31, or may be electrically connected to the outer side wall of the porous conductive ceramic 31 at the first end. Similarly, the first negative pin 36 may be electrically connected to an end face of the second end of the porous conductive ceramic 31, or may be electrically connected to the outer side wall of the porous conductive ceramic 31 at the second end, as long as the porous conductive ceramic 31 can be powered and heat normally. The implementation is not specifically limited in the present embodiment.

In the present embodiment, with the air heater 3 based on the above structural designs, a portion of the porous conductive ceramic 31 where a current flows through can be powered and generate heat when the first positive pin 35 and the first negative pin 36 are connected to a power supply. When cool air from the exterior flows into internal pores of the porous conductive ceramic 31 from the air channel 21, the cool air with a relatively low temperature is heated to be hot air with a relatively high temperature, thereby performing the air heating. Furthermore, since the whole porous conductive ceramic 31 directly generates heat after being powered, the inner wall of the first cavity 221 generates heat quickly after the porous conductive ceramic 31 is powered, thereby the first herb segment 11 is preheated at the preheating stage of the aerosol generating device. It should be particularly noted that, an air heat exchanger based on a metal resistor in the related art is arranged in a manner that, a metal resistor is provided in a flowing path between the air channel 21 and the first cavity 221, where the metal resistor may be of a heating sheet, a heating mesh, a heating wire or the like. The cool air flowing from the exterior is heated to be hot air by the heat generated by the metal resistor being powered, and the hot air flows into the first cavity 221 and atomizes the first herb segment 11 inside the first cavity 221. Compared with the air heat exchanger based on the metal resistor in the related art, the porous conductive ceramic 31 according to the present embodiment serves as the air heater. Since the air heated by the porous conductive ceramic 31 does not have a metallic taste, the smoking taste of the user can be improved. Moreover, since the herbal product cannot be preheated by the hot air at the preheating stage of the aerosol generating device, the heat can be radiated outwards only after the metal resistor heats the inner wall of the first cavity 221 when the air heat exchanger based on the metal resistor is powered. Thus, the heat has to be conducted from the metal resistor to the inner wall of the first cavity 221, and thus the heat loss is high, and relatively high power is required to achieve a demanded preheating performance. In contrast, the air heater 3 based on the porous conductive ceramic 31 according to the present embodiment can directly generate heat as a whole after being powered, and the heat generated on the inner wall of the first cavity 221 can be quickly conducted to the first herb segment 11. Therefore, compared with the air heat exchanger based on the metal resistor, the heat loss is lower, which helps to reduce the preheating time of the first herb segment 11 at the preheating stage of the aerosol generating device, and consumes less power.

FIG. 16 is a sectional view of a segmented heating device according to an embodiment of the present application.

In some embodiments, referring to FIG. 16, in an exemplary embodiment of the present application, an end of the porous conductive ceramic 31 where the first positive pin 35 is connected and another end of the porous conductive ceramic 31 where the first negative pin 36 is connected are at two corners on a diagonal of an axial section of the porous conductive ceramic 31. In this way, when the porous conductive ceramic 31 is powered, the current can flow through the whole porous conductive ceramic 31 more evenly, and the porous conductive ceramic 31 can generate heat more evenly, and thus the air is heated more evenly and the first herb segment 11 is preheated more evenly. In the present embodiment, it may be understood that, suppose that the axial section of the porous conductive ceramic 31 is a rectangle, the end of the porous conductive ceramic 31 where the first positive pin 35 is connected is referred to as a first positive connection end for short, and the other end of the porous conductive ceramic 31 where the first negative pin 36 is connected is referred to as a first negative connection end for short, a line connecting the first positive connection end and the first negative connection end can be approximated as a diagonal of the rectangle.

In some embodiments, referring to FIGS. 14 and 15, in an exemplary embodiment of the present application, the air channel 21 is located between an inner wall of the outer housing 2 and an outer wall of the peripheral heater 4, and the air flowing through the air channel 21 can flow into the first cavity 221 through the end face of the end of the porous conductive ceramic close to the peripheral heater 4. For example, in some application cases having the preheating stage, the air heater 3 and the peripheral heater 4 are turned on at the same time to preheat the herbal product before the hot air heats and atomizes the first herb segment 11. Since the air channel 21 is provided between the inner wall of the outer housing 2 and the outer wall of the peripheral heater 4, the temperature of the air flowing into the air channel 21 from the exterior can be increased by excess heat generated by the peripheral heater 4, whereby the air heater 3 can heat the air that flows through the air channel 21 and enters the first cavity 221 up to the required temperature more quickly. In this way, not only is the utilization efficiency of the heat increased, but also the operation time of the air heater 3 is reduced to save power.

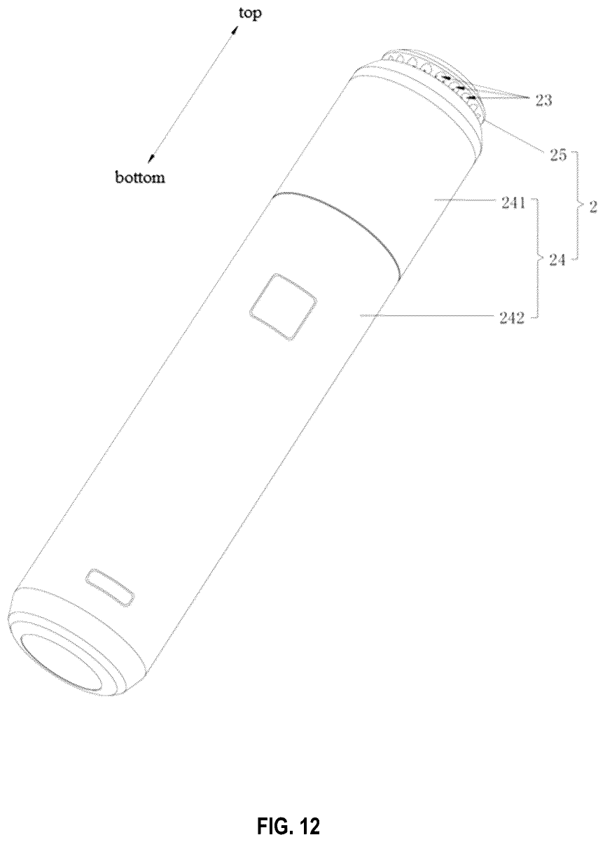

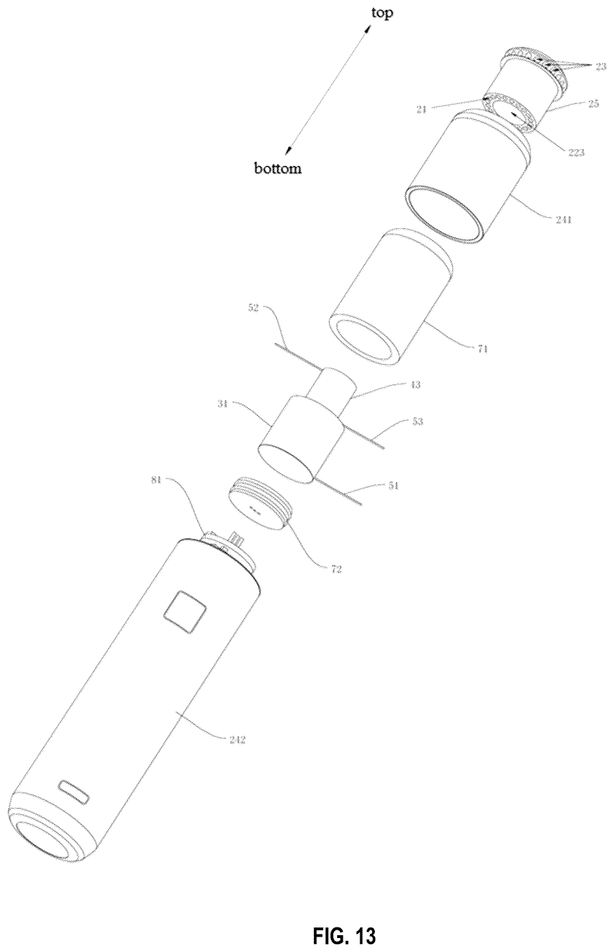

FIG. 12 is a schematic view showing the overall structure of an aerosol generating device according to another embodiment of the present application. FIG. 13 is an exploded view showing the structure of an aerosol generating device according to another embodiment of the present application.

In some embodiments, referring to FIGS. 12 to 15, in an exemplary embodiment of the present application, the outer housing 2 includes a main housing 24 and a cover 25 that is provided at an upper portion of the main housing 24. The air heater 3 and the peripheral heater 4 are both mounted inside the main housing 24. The cover 25 is provided with a third cavity 223 that is hollow for the herbal product to be inserted into. The cover 25 is mounted outside the peripheral heater 4, and the third cavity 223 is in communication with the second cavity 222. At least one air channel 21 is provided between an inner wall of the cover 25 and an outer wall of the cover 25, and a side wall at an end portion of an end of the cover 25 away from the porous conductive ceramic 31 is provided with at least one first air inlet hole 23 in communication with the air channel 21. Illustratively, multiple air channels 21 are provided annularly between the inner wall of the cover 25 and the outer wall of the cover 25. The side wall at the end portion of the end of the cover 25 away from the porous conductive ceramic 31 is provided with multiple first air inlet holes 23 in communication with the multiple air channels 21. In actual implementations, the cover 25 may be made of polyethylene or other materials, as long as the cover 25 performs thermal insulation to some degree. The implementation is not specifically limited in the present embodiment.

In the present embodiment, based on the above structural designs, with the cover 25 having the first air inlet hole 23 and the air channel 21, on one hand, the air channel 21 can be easily provided between the inner wall of the outer housing 2 and the outer wall of the peripheral heater 4, such that the air flowing through the air channel 21 takes advantage of the excess heat generated by the peripheral heater 4, thereby reducing power consumption of the air heater 3. On the other hand, the first air inlet hole 23 is provided on the side wall at the end portion of the cover 25, thereby reducing a risk brought by a situation that, the air inlet hole 23 is blocked by the mouth or the hand of the user during smoking, thus the air from the exterior smoothly enters the air heater 3 to be heated and used.

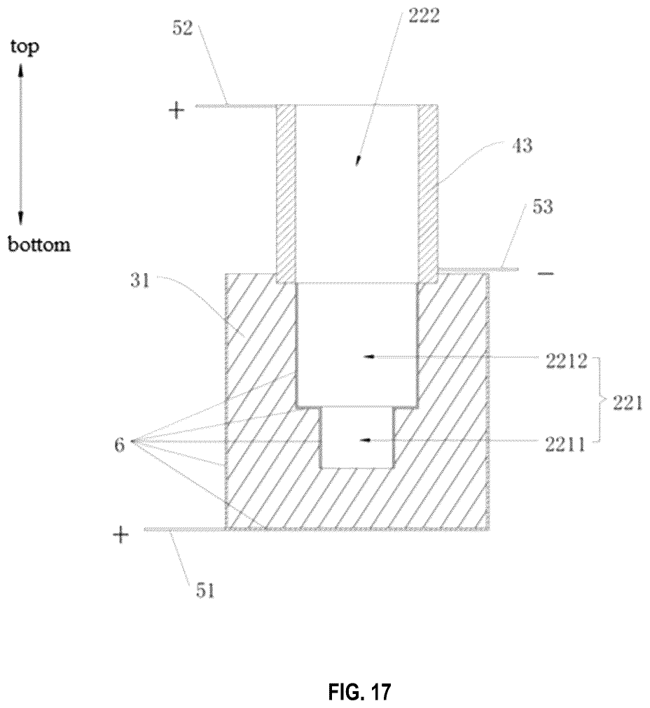

FIG. 17 is a sectional view of a segmented heating device according to another embodiment of the present application.

In some embodiments, referring to FIGS. 15 to 17, in an exemplary embodiment of the present application, the first cavity 221 of the porous conductive ceramic 31 is a stepped blind hole, and the stepped blind hole includes a first hole channel 2211 and a second hole channel 2212 that accommodates the first herb segment 11. The second hole channel 2212 is located between the first hole channel 2211 and the second cavity 222, and a diameter of the second hole channel 2212 is larger than a diameter of the first hole channel 2211. In this way, since the first cavity 221 is the stepped blind hole, it can serve as an air channel for the hot air to flow out, such that the hot air can preheat or heat and atomize the herbal product along the direction from the first herb segment 11 to the second herb segment 12. A bottom wall of the second hole channel 2212 may serve as a limiting step to prevent the first herb segment 11 from being inserted so deeply that the air channel is blocked. In this way, the hot air generated by the porous conductive ceramic 31 during operation can flow into the herbal product more smoothly for preheating or heating and atomizing.

In some embodiments, referring to FIGS. 15 to 17, in an exemplary embodiment of the present application, an inner circumferential wall of the second hole channel 2212 and an outer circumferential wall of the porous conductive ceramic 31 may be covered by a dense sealing layer 6. That is to say, only the inner circumferential wall of the second hole channel 2212 is covered by the dense sealing layer 6, or only the outer circumferential wall of the porous conductive ceramic 31 is covered by the dense sealing layer 6, or both the inner circumferential wall of the second hole channel 2212 and the outer circumferential wall of the porous conductive ceramic 31 are covered by the dense sealing layer 6, which is not specifically limited herein. Illustratively, both the inner circumferential wall of the second hole channel 2212 and the outer circumferential wall of the porous conductive ceramic 31 are covered by the dense sealing layer 6. In actual implementations, the sealing layer 6 may be a dense ceramic glaze layer, or a dense teflon coating, or made of other dense heat resisting materials, as long as the sealing layer 6 can prevent air leakage. The implementation is not specifically limited in the present embodiment. In the present embodiment, with the dense sealing layer 6 provided on the inner circumferential wall of the second hole channel 2212, the hot air can intensively flow out of the first hole channel 2211, such that the hot air can evenly heat the herbal product from bottom to top. With the dense sealing layer 6 provided on the outer circumferential wall of the porous conductive ceramic 31, the hot air is prevented from escaping to the exterior, thereby increasing the utilization rate of the hot air. Preferably, the outer circumferential wall of the porous conductive ceramic 31, the bottom face of the porous conductive ceramic 31, an inner circumferential wall of the first hole channel 2211 and the inner circumferential wall of the second hole channel 2212 are all covered by the dense sealing layer 6, while the top face of the porous conductive ceramic 31 is not provided with the sealing layer 6, such that the air from the exterior can enter the porous conductive ceramic 31. In this way, the hot air can intensively flow out of a bottom wall of the first hole channel 2211 and evenly heat the herbal product from bottom to top. Furthermore, the air flowing from the air channel 21 to the internal pores of the porous conductive ceramic 31 can flow through each part of the porous conductive ceramic 31 thoroughly to fully utilize the internal heating space of the porous conductive ceramic 31, thereby further increasing the efficiency of the air heater 3 when heating the air.

In some embodiments, in some specific embodiments, the peripheral heater 4 may employ the following structural forms. Specifically, referring to FIG. 15 and FIG. 16, in an exemplary embodiment of the present application, the peripheral heater 4 includes a second positive pin 41, a second negative pin 42 and a dense conductive ceramic 43 having the second cavity 222. The dense conductive ceramic 43 includes a third end and a fourth end that are opposite to each other. The second positive pin 41 is electrically connected to the third end of the dense conductive ceramic 43 (i.e., a lower end of the dense conductive ceramic 43), and the second negative pin 42 is electrically connected to the fourth end of the dense conductive ceramic 43 (i.e., an upper end of the dense conductive ceramic 43). It may be understood that, in actual implementations, an end portion of the second positive pin 41 may be electrically connected to an end face of the third end of the dense conductive ceramic 43, or may be electrically connected to an outer side wall of the dense conductive ceramic 43 at the third end. Similarly, an end portion of the second negative pin 42 may be electrically connected to an end face of the fourth end of the dense conductive ceramic 43, or may be electrically connected to the outer side wall of the dense conductive ceramic 43 at the fourth end, as long as the dense conductive ceramic 43 can be powered and generate heat normally. The implementation is not specifically limited in the present embodiment.

In the present embodiment, with the peripheral heater 4 based on the above structural designs, when the second positive pin 41 and the second negative pin 42 are connected to the power supply, a portion of the dense conductive ceramic 43 where a current flows through can be powered and generate heat, thus the dense conductive ceramic 43 can perform the peripheral heating, i.e., preheat or heat and atomize the second herb segment 12 from inside to outside. Besides, as described above, the heating tube based on the metal resistor includes the hollow tube body and the metal resistor attached to the surface of the tube body. When the heating tube based on the metal resistor is powered, only if the metal resistor heats the tube body can the heat be radiated outwards. The heat conduction from the metal resistor to the tube body leads to a relatively high heat loss. The peripheral heater 4 based on the dense conductive ceramic 43 according to the present embodiment can directly generate heat as a whole after being powered, and the generated heat can be quickly conducted to the second herb segment 12. Therefore, compared with the heating tube based on the metal resistor, the heat loss is lower, and the conversion efficiency from electrical power to heat is higher, which helps to reduce the time required for preheating or heating and atomizing the second herb segment 12.

In some embodiments, referring to FIG. 15 and FIG. 16, in an exemplary embodiment of the present application, an end of the dense conductive ceramic 43 where the second positive pin 41 is connected and another end of the dense conductive ceramic 43 where the second negative pin 42 is connected are at two corners on a diagonal of an axial section of the dense conductive ceramic 43. In this way, when the dense conductive ceramic 43 is powered, the current can flow through the whole dense conductive ceramic 43 more evenly, thus the dense conductive ceramic 43 can generate heat more evenly, so as to heat the second herb segment 12 more evenly. In the present embodiment, it may be understood that, suppose that the axial section of the dense conductive ceramic 43 is a rectangle, and the end of the dense conductive ceramic 43 where the second positive pin 41 is connected is referred to as a second positive connection end for short, and the other end of the dense conductive ceramic 43 where the second negative pin 42 is connected is referred to as a second negative connection end for short, a line connecting the second positive connection end and the second negative connection end can be approximated as a diagonal of the rectangle. In an embodiment, the porous conductive ceramic 31 and the dense conductive ceramic 43 are coaxially arranged.

In some embodiments, referring to FIG. 16, when the porous conductive ceramic 31 performs the air heating and the dense conductive ceramic 43 performs the peripheral heating, if the third end of the dense conductive ceramic 43 and the first end of the porous conductive ceramic 31 directly contact each other and are electrically connected, the segmented heating device can still be controlled to heat in a segmented manner. However, the dense conductive ceramic 43 and the porous conductive ceramic 31 cannot work at the same time. This is because that, when each electrode is connected to the power supply, a current can not only flow from the first positive pin 35 to both the first negative pin 36 and the second negative pin 42, but also flow from the second positive pin 41 to both the first negative pin 36 and the second negative pin 42. As a result, the current flowing through the dense conductive ceramic 43 and the porous conductive ceramic 31 may easily get so large that the dense conductive ceramic 43 and the porous conductive ceramic 31 are burn out. In view of this, to improve the flexibility of the segmented heating device in use, and to enable the dense conductive ceramic 43 and the porous conductive ceramic 31 to not only work at the same time but also work at different stages, in an optional embodiment, the third end of the dense conductive ceramic 43 and the first end of the porous conductive ceramic 31 are spaced apart or connected in an insulative manner. In this way, a current flowing through the dense conductive ceramic 43 and a current flowing through the porous conductive ceramic 31 are independent from each other, such that the dense conductive ceramic 43 and the porous conductive ceramic 31 can work at the same time without being burn out. It should be noted that, the third end of the dense conductive ceramic 43 and the first end of the porous conductive ceramic 31 may be connected in an insulative manner by interference fit, transition fit, thread fit or the like. At the same time, a position where the third end of the dense conductive ceramic 43 and the first end of the porous conductive ceramic 31 contact each other is coated with an insulating ceramic glaze layer, an insulating paint or the like to achieve electrical insulation. Certainly, other means may be employed for the insulative connection between the third end of the dense conductive ceramic 43 and the first end of the porous conductive ceramic 31, as long as the insulative connection is achieved. The implementation is not specifically limited in the present embodiment.

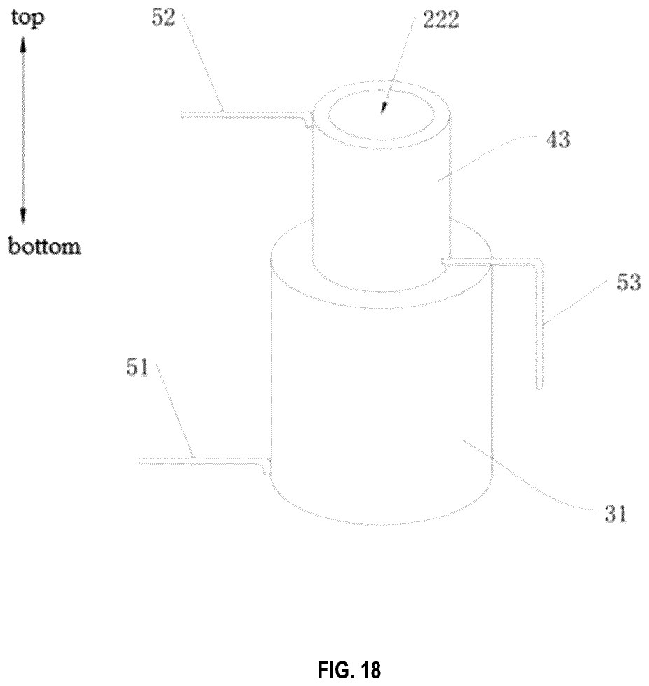

In some embodiments, referring to FIG. 15, FIG. 17, and FIG. 18, in another exemplary embodiment of the present application, the segmented heating device includes a negative wire 53, a first positive wire 51 and a second positive wire 52. The air heater 3 includes a porous conductive ceramic 31 having the first cavity 221, and the peripheral heater 4 includes a dense conductive ceramic having the second cavity 222. The porous conductive ceramic 31 includes a first end and a second end that are opposite to each other, and the dense conductive ceramic 43 includes a third end and fourth end that are opposite to each other. The first end of the porous conductive ceramic 31 and the third end of the dense conductive ceramic 43 are connected in an insulative manner. The negative wire 53 is electrically connected to the first end of the porous conductive ceramic 31 and the third end of the dense conductive ceramic 43, the first positive wire 51 is electrically connected to the second end of the porous conductive ceramic 31, and the second positive wire 52 is electrically connected to the fourth end of the dense conductive ceramic 43. Optionally, the porous conductive ceramic 31 and the dense conductive ceramic 43 are coaxially arranged. An end of the dense conductive ceramic 43 where the negative wire 53 is connected and another end of the dense conductive ceramic 43 where the second positive wire 52 is connected are at two corners on a diagonal of an axial section of the dense conductive ceramic 43. An end of the porous conductive ceramic 31 where the negative wire 53 is connected and another end of the porous conductive ceramic 31 where the first positive wire 51 is connected are at two corners on a diagonal of an axial section of the porous conductive ceramic 31.

It may be understood that, the segmented heating device according to the present embodiment differs from the segmented heating device shown in FIG. 16 in that, the porous conductive ceramic 31 and the dense conductive ceramic 43 share a same electrode. That is, the number of the electrodes used in the segmented heating device according to the present embodiment is decreased. The negative wire 53, the first positive wire 51, the second positive wire 52, the first positive pin 35, the second positive pin 41, the first negative pin 36 and the second negative pin 42 may be made of a same material or different materials. For example, they are made of a same metal material, or different metal materials, as long as they are conductive. The implementation is not specifically limited herein. The first end of the porous conductive ceramic 31 and the third end of the dense conductive ceramic 43 may be connected by interference fit, transition fit, thread fit or the like. At the same time, a position where the first end of the porous conductive ceramic 31 and the third end of the dense conductive ceramic 43 contact each other is coated with an insulating ceramic glaze layer, an insulating paint or the like to achieve electrical insulation. Certainly, other means may be employed for the insulative connection between the first end of the porous conductive ceramic 31 and the third end of the dense conductive ceramic 43, as long as the insulative connection is achieved. The implementation is not specifically limited in the present embodiment.

In the present embodiment, it may be understood that, the porous conductive ceramic 31 and the dense conductive ceramic 43 are both made of conductive ceramics, and differing in that, the porous conductive ceramic 31 is of a porous structure with pores, while the dense conductive ceramic 43 is of a dense structure without pores. This difference results from different forming processes. The forming processes of the porous conductive ceramic 31 and the dense conductive ceramic 43 are both mature processes in this technical field, which are not described in detail herein.

In the present embodiment, with the segmented heating device based on the above structural designs, when the negative wire 53 and the first positive wire 51 are connected to the power supply, the porous conductive ceramic 31 can directly generate heat as a whole to perform the air heating and perform preheating on the first herb segment 11. When the negative wire 53 and the second positive wire 52 are connected to the power supply, the dense conductive ceramic 43 can directly generate heat as a whole to perform the peripheral heating. Since the porous conductive ceramic 31 and the dense conductive ceramic 43 are both made of conductive ceramics, they can be sintered into a whole to reduce the producing cost of the segmented heating device.

In some embodiments, referring to FIGS. 13 to 15, in an exemplary embodiment of the present application, an thermal insulation layer 7 may be provided between the inner wall of the outer housing 2 and the outer wall of the porous conductive ceramic 31, or an thermal insulation layer 7 may be provided between the inner wall of the outer housing 2 and the outer wall of the peripheral heater 4, or thermal insulation layers 7 may be provided both between the inner wall of the outer housing 2 and the outer wall of the porous conductive ceramic 31 and between the inner wall of the outer housing 2 and the outer wall of the peripheral heater 4 respectively, which are not limited herein. Illustratively, the thermal insulation layer 7 includes a thermal insulation tube 71 and a thermal insulation pad 72. The thermal insulation tube 71 is mounted outside the cover 25 and outside the porous conductive ceramic 31, and is located between the inner wall of the outer housing 2 and the segmented heating device. The thermal insulation pad 72 is located at the bottom portion of the porous conductive ceramic 31.

In the present embodiment, based on the above structural designs, with the thermal insulation layers 7 arranged both between the inner wall of the outer housing 2 and the outer wall of the porous conductive ceramic 31 and between the inner wall of the outer housing 2 and the outer wall of the peripheral heater 4 respectively, the heat loss of the porous conductive ceramic 31 and the peripheral heater 4 during operation is reduced, which is beneficial to improving the heating efficiency of the porous conductive ceramic 31 and the peripheral heater 4. Furthermore, the user is prevented from bad experience of burning hands when holding the outer housing 2 by hand to smoke. In actual implementations, the thermal insulation layer 7 may be made of aerogels, foams, ceramic fibers or other thermal insulating materials, as long as using requirements are satisfied. The implementation is not specifically limited in the present embodiment.

In some embodiments, referring to FIGS. 13 to 15, in an exemplary embodiment of the present application, the aerosol generating device includes a power supply assembly 8 mounted inside the outer housing 2, and the power supply assembly 8 includes a control board 81 and a power supply 82. Illustratively, the outer housing 2 includes the main housing 24 and the cover 25 described hereinabove. The main housing 24 includes a first housing portion 241 and a second housing portion 242. The air channel 21 and the segmented heating device are arranged inside the first housing portion 241. The control board 81 and the power supply 82 are arranged inside the second housing portion 242. The control board 81 is electrically connected to the power supply 82, the porous conductive ceramic 31 and the peripheral heater 4. The power supply 82 may be a lithium battery or other types of batteries. The control board 81 is configured to control the operation of the porous conductive ceramic 31 and the peripheral heater 4. When the herbal product is inserted into the corresponding cavities of the aerosol generating device, the control board 81 controls the power supply 82 to supply power to the porous conductive ceramic 31 and the peripheral heater 4.

FIG. 18 is a perspective schematic view showing the structure of the segmented heating device shown in FIG. 17.

Correspondingly, referring to FIGS. 12 to 18, a segmented heating device is further provided according to an embodiment of the present application, which is the segmented heating device of the aerosol generating device shown in FIGS. 12 to 18. That is, the segmented heating device in this embodiment can be applied to the aerosol generating device shown in FIGS. 12 to 18. The aerosol generating device at least includes the outer housing 2. The air channel 21 and a mounting space for accommodating the segmented heating device are provided in the outer housing 2. The segmented heating device includes the porous conductive ceramic 31 and the peripheral heater 4 connected to the porous conductive ceramic 31. The porous conductive ceramic 31 is provided inside the outer housing 2 and is provided with the first cavity 221 that accommodates the first herb segment 11 and is in communication with the air channel 21. The peripheral heater 4 is provided inside the outer housing 2 and is located above the porous conductive ceramic 31. The peripheral heater 4 is provided with the second cavity 222 that accommodates the second herb segment 12 and is in communication with the first cavity 221. In actual use, the segmented heating device is mounted in the mounting space of the outer housing 2, such that the porous conductive ceramic 31 of the segmented heating device is in communication with the air channel 21. The segmented heating device is electrically connected to the power supply part of the aerosol generating device by wires or the like, such that the segmented heating device performs segmented heating after being powered. That is, the segmented heating device performs air heating through the porous conductive ceramic 31 and performs peripheral heating through the peripheral heater 4. In the present embodiment, it should be noted that, other contents of the segmented heating device may refer to the above descriptions in the embodiments of the aerosol generating device, which are not described in detail herein.

It should be noted that, other contents of the heat exchanger, the segmented heating device and the aerosol generating device in the embodiments of the present application may refer to the related art, which are not described in detail herein.

The above is only the preferred embodiments of the present application, and is not therefore limiting the scope of the patent of the present application. Equivalent structure changes made in the application specification and drawings, or directly or indirectly applied in other related technical fields, are intended to be included within the patent protection scope of the present application.

What is claimed is:

1. An aerosol generating device for heating a herbal product, comprising an outer housing and an air heater, wherein:
an air channel and an accommodation cavity for accommodating the herbal product are provided in the outer housing, the outer housing is provided with at least one first air inlet hole, and air from an exterior is capable of entering into the air channel through the at least one first air inlet hole; and
the air heater comprises a porous conductive ceramic mounted in the outer housing, at least a part of the porous conductive ceramic is located between the accommodation cavity and the air channel, and a plurality of pores for air to pass through are distributed throughout the porous conductive ceramic, and the porous conductive ceramic is configured to heat air flowing through the porous conductive ceramic and entering the accommodation cavity, thereby allowing the air after being heated to heat the herbal product.

2. The aerosol generating device according to claim 1, wherein the at least one first air inlet hole is provided at an end portion of an end of the outer housing away from the accommodation cavity.

3. The aerosol generating device according to claim 1, wherein an interlayer having a cavity is provided in a side wall of the outer housing, and the at least one first air inlet hole is provided at a top end of the interlayer at an end of the outer housing close to the accommodation cavity.

4. The aerosol generating device according to claim 1, wherein an interlayer having a cavity is provided in a side wall of the outer housing, and the first air inlet hole is defined on the side wall of the outer housing at an end of the outer housing close to the accommodation cavity.

5. The aerosol generating device according to claim 1, wherein a porosity of the porous conductive ceramic ranges from 30% to 70%.

6. The aerosol generating device according to claim 1, wherein a pore-opening degree of the porous conductive ceramic is larger than or equal to 90%.

7. The aerosol generating device according to claim 1, wherein at least one layer of a thermal insulation material is provided outside an outer surface of the porous conductive ceramic, and the thermal insulation material is provided with at least one second air inlet hole in communication with the air channel and at least one air outlet hole in communication with the accommodation cavity.

8. The aerosol generating device according to claim 1, wherein the air heater comprises a positive pin and a negative pin, and the porous conductive ceramic is electrically connected to the positive pin and the negative pin.

9. The aerosol generating device according to claim 1, wherein the porous conductive ceramic is of a cylindrical shape, a conical shape, a helical shape, a trapezoidal shape, a dumbbell shape, a concave shape, a spherical shape, or an irregular shape.

10. The aerosol generating device according to claim 1, wherein the porous conductive ceramic is vertically and coaxially arranged inside the outer housing.

11. The aerosol generating device according to claim 1, wherein the porous conductive ceramic is transversely arranged in the outer housing, and a certain included angle is formed between an axial direction of the porous conductive ceramic and an axial direction of the outer housing.

12. The aerosol generating device according to claim 1, comprising a power supply assembly, wherein the power supply assembly is mounted in the outer housing and electrically connected to the porous conductive ceramic.

13. The aerosol generating device according to claim 1, wherein
the herbal product comprises a first herb segment and a second herb segment connected as a whole;
the aerosol generating device comprises a segmented heating device, the segmented heating device comprising a peripheral heater and the air heater, and the accommodation cavity comprising a first cavity and a second cavity;
the porous conductive ceramic is provided with the first cavity configured to accommodate the first herb segment and in communication with the air channel; and
the peripheral heater is provided in the outer housing and is located above the porous conductive ceramic, and the peripheral heater is provided with the second cavity configured to accommodate the second herb segment and in communication with the first cavity.

14. The aerosol generating device according to claim 13, wherein
the air heater comprises a first positive pin and a first negative pin, and the porous conductive ceramic comprises a first end and a second end opposite to each other; and
the first positive pin is electrically connected to the first end, and the first negative pin is electrically connected to the second end.

15. The aerosol generating device according to claim 14, wherein an end of the porous conductive ceramic connected to the first positive pin and another end of the porous conductive ceramic connected to the first negative pin are at two corners on a diagonal of an axial section of the porous conductive ceramic; and/or
a material of the porous conductive ceramic is porous conductive ceramic or porous metal.

16. The aerosol generating device according to claim 14, wherein
the peripheral heater comprises a second positive pin, a second negative pin, and a dense conductive ceramic provided with the second cavity, and the dense conductive ceramic comprises a third end and a fourth end opposite to each other; and
the second positive pin is electrically connected to the third end, and the second negative pin is electrically connected to the fourth end.

17. The aerosol generating device according to claim 13, wherein
the segmented heating device comprises a negative wire, a first positive wire, and a second positive wire, and the peripheral heater comprises a dense conductive ceramic having the second cavity;
the porous conductive ceramic comprises a first end and a second end opposite to each other, and the dense conductive ceramic comprises a third end and fourth end opposite to each other; and
the first end and the third end are connected in an insulative manner, the negative wire is electrically connected to the first end and the third end, the first positive wire is electrically connected to the second end, and the second positive wire is electrically connected to the fourth end.

18. The aerosol generating device according to claim 13, wherein the air channel is provided between an inner wall of the outer housing and an outer wall of the peripheral heater, and air flowing through the air channel flows into the first cavity through an end face of an end of the porous conductive ceramic close to the peripheral heater.

19. A heat exchanger, which is the air heater of the aerosol generating device according to claim 1.

20. A segmented heating device of an aerosol generating device according to claim 16.
